(19) United States
(12) Patent Application Publication
(10) Pub. No.: US 2006/0137549 A1
(43) Pub. Date: Jun. 29, 2006

(54) Device for making a printed ticket available

(75) Inventor: Eric Pallier, Viry Chatillon (FR)

Correspondence Address: YOUNG & THOMPSON, 745 SOUTH 23RD STREET, 2ND FLOOR, ARLINGTON, VA, 22202, US

(73) Assignee: AXIOHM, MONTROUGE (FR)

(21) Appl. No.: 11/296,410

(22) Filed: Dec. 8, 2005

(30) Foreign Application Priority Data
Dec. 29, 2004 (FR) 04 14014

(51) Int. Cl. B41K 3/08

(52) U.S. Cl. 101/66

(57) ABSTRACT

A device for making a printed ticket available, the device being comprising at least three rollers or lines of wheels rotatable about respective parallel axes extending substantially transversely across the path of the ticket and situated, in end view, at the vertices of a triangle and defining two ticket pinch lines, one between a first roller and a second roller, and the other between said second roller and a third roller, a first deflector surface co-operates with the first roller to define a first guide for guiding the ticket from a ticket supply source to a first pinch line, a second deflector surface co-operates with the second roller to define a second guide for guiding the ticket from the first pinch line to a second pinch line, and the third roller co-operates with a third deflector surface to define a third guide for guiding the ticket from the second pinch line to a ticket collection channel, the three guides being inscribed within the above-mentioned triangle.

The present invention relates to a device for making a ticket available to a user, the ticket having printed thereon data about a transaction in which the user has participated. For example it may be a check-out ticket.

### BACKGROUND OF THE INVENTION

Such tickets are of lengths that vary from one user to another depending mainly on the number of lines of printing. Printing takes place progressively as data is being input, and it is advantageous while printing is taking place for the ticket coming from the machine to be stored temporarily in a buffer state prior to being delivered all at once to the user, so as to avoid impeding input or so as to ensure that the ticket is not torn or dirtied.

Devices that perform this function are known. Such devices are illustrated by way of example by documents U.S. Pat. No. 5,215,393 or U.S. Pat. No. 5,879,090. Nevertheless, those mechanisms are not adapted to satisfying the requirements for fitting to an opening printer machine that makes it very easy to install the paper tape from which the tickets are taken. Such mechanisms require complicated handling when putting into place the paper tape that passes through them.

### OBJECT OF THE INVENTION

The present invention proposes remedying that drawback by implementing a particular structure for a mechanism that is to deliver a printed ticket, which mechanism is not only fully opening downstream from a printer, but is also compact at the outlet from the printer, thus enabling it to be installed on printers that are already in place.

### BRIEF SUMMARY OF THE INVENTION

To this end, the invention thus provides a device for making a printed ticket available, the device comprising at least three rollers or lines of wheels rotatable about respective parallel axes extending substantially transversely across the path of the ticket and situated, in end view, at the vertices of a triangle and defining two ticket pinch lines.

A first deflector surface co-operates with the first roller to define a first guide for guiding the ticket from a ticket supply source to a first pinch line. A second deflector surface co-operates with the second roller to define a second guide for guiding the ticket from the first pinch line to a second pinch line. Finally, the third roller co-operates with a third deflector surface to define a third guide for guiding the ticket from the second pinch line to a ticket collection channel, the three guides being inscribed within the above-mentioned triangle.

This provides a structure that is extremely compact and that, as described below, operates like a rail switch to convey the ticket coming from a printer firstly towards a storage space, and then without letting it go, to bring it to a position where it is available to the user. If the user forgets to take the ticket, then the device of the invention enables the ticket to be “swallowed” and taken to a recovery space in order to release the device for the following user.

The switching function is performed in particular by the fact that the ends of the first deflector surface and of the second deflector surface that are both adjacent to the first pinch line constitute two faces that converge towards said line belonging to a single moving part that is subjected to a return force acting towards the first above-mentioned roller. This moving part may be a deflector flap subjected to the effect of a spring or a resilient extension having shape memory that belongs to a part carrying the first and second deflector surfaces. This characteristic is similar to a rail switch that in one direction extends away from a passing wheel, and in the other direction takes charge of the wheel in order to change the path it follows.

One of the rollers of the device is coupled to a drive motor, which motor is controlled together with the motor of the ticket printer.

The device naturally includes a magazine for temporarily storing the ticket, which magazine is situated beyond the first pinch line, outside the above-mentioned triangle.

The device also includes a detector that detects a transverse edge of the paper passing into the second above-mentioned guide between the end of the moving part and the first pinch line.

Finally, the device comprises two parts that are movable relative to each other between an in-service position in which the first and second deflector surfaces are close to the corresponding rollers, the second pinch line being active, and an open position in which the first and second deflector surfaces are moved away at least in part from the corresponding rollers, as are the second and third rollers, such that a strip of paper can pass freely between the two portions while they are in their second position.

Other characteristics and advantages of the invention appear on reading the following description of an embodiment.

### BRIEF DESCRIPTION OF THE DRAWINGS

Reference is made to the accompanying drawings, in which:

FIG. 1 is a cross-section view of the device of the invention associated with a ticket printer machine;

FIG. 2 is a general perspective view of the FIG. 1 device associated with an opening structure that possesses a printer and a space for storing a roll of paper from which tickets are taken;

FIG. 3 is a fragmentary section view showing a detail of FIG. 2; and

FIGS. 4, 5, and 6 are show three main stages in the operation of the device of the invention.

### DETAILED DESCRIPTION OF THE INVENTION

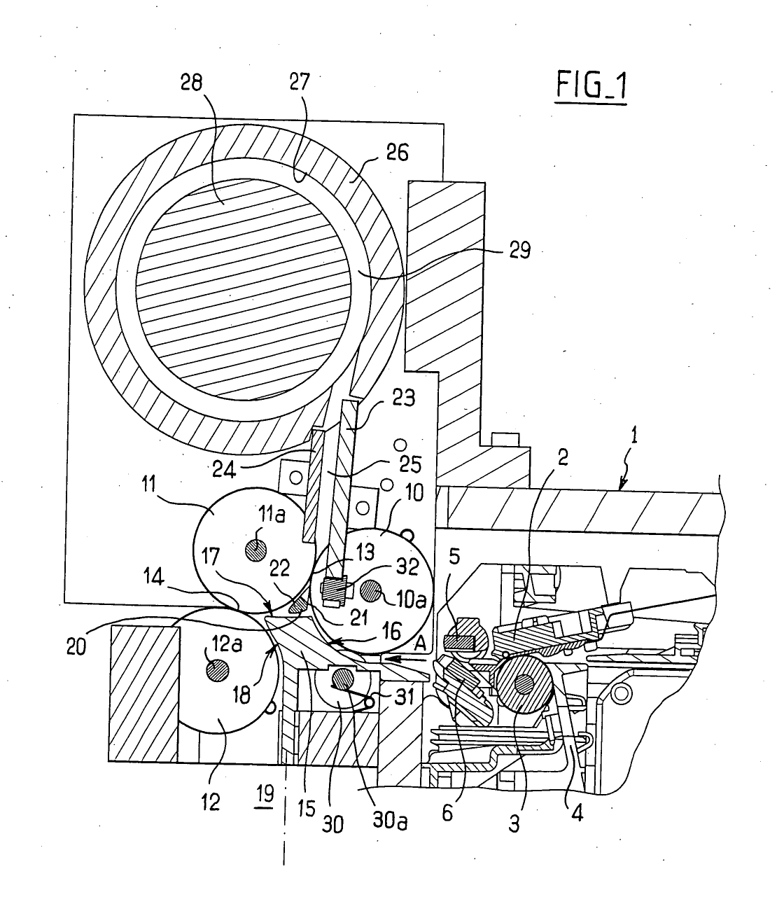

FIG. 1 shows a thermal printer housed in a casing 1 and comprising in conventional manner a print head that presses against a generator line of a drive roller or capstan 3 for printing a strip of paper (not shown) traveling along a passage 4 from a roll stored under the print head. The strip of printed paper coming from the print head is guided between two blades 5, 6 of a conventional cutter device shown in this example as being constituted by a rotary blade 5 and a stationary blade 6.

Thus, a printed ticket leaves the print head along arrow A progressively as it is being printed. At the end of printing, the ticket is detached from the strip by the cutter device 5, 6, and would normally drop out from the printer into a basket for collecting it and keeping it available to the user. Those usual dispositions are suitable for small tickets such as the bill slips issued by automatic payment devices, e.g. situated on fuel dispensers or on automatic teller machines (ATMs). However, once the ticket is in danger of becoming long, as often happens at supermarket checkouts, it becomes increasingly necessary to organize the handling and the handing over to the user in a manner that avoids any need for the clerk to handle the ticket, and to ensure that the ticket does not become dirty or torn, while also accommodating the behavior of users who can either take the ticket or leave it behind.

Thus, according to the invention, a device is installed at the outlet from the printer, the device comprising three rollers 10, 11, 12 extending in parallel and turning about respective axes 10a, 11a, and 12a extending across the travel direction of the ticket. These axes (seen in end view) are situated at the vertices of a triangle of dimensions such that the rollers 10 and 11 come into contact with each other along a generator line forming a first pinch line 13 for the ticket, and while the rollers 11 and 12 are in contact along a second ticket-pinching generator line 14. The rollers 10 and 12 do not come into contact with each other. A motor (not shown) is coupled to one of the rollers, e.g. the roller 11 so as to rotate it in either direction.

It should be understood, in the meaning of the invention, that the term “roller” also covers a succession of wheels carried on the axes in question, said wheels being spaced apart from one another along each of these axes but facing one another in pairs from one axis to another.

A portion of structure 15 presents a deflector surface 16 facing the roller 10 and going round part of the roller. The same portion 15 possesses another deflector surface 17 facing the roller 11. Finally, the portion 15 has a third deflector surface 18 situated facing the roller 12.

It should be observed that at the top of the part 15 in the corner formed between the rollers 10 and 11 in the vicinity of the pinch line 13, there is a deflector flap 20 having one face 21 substantially in line with the deflector surface 16, and another face 22 that converges towards the face 21 going towards the pinch line of contact 13 serving to extend or precede the deflector surface 17 of the part 15. Thus, the faces 16 and 21 co-operate with the roller 10 to define the first paper guide leading from the printer outlet to the pinch line 13, while the surfaces 22 and 17 co-operate with the roller 11 to constitute a second guide for the paper leading from the pinch line 13 to the pinch line 14, and the deflector surface 18 co-operates with the roller 12 to constitute a third guide for the paper so as to bring it from the pinch line 14 to the inlet of a receptacle 19 fitted to or integrated in the structure that carries the part 15. These three guides are located in the triangle 10a, 11a, 12a.

Above the pinch line 13, the device of the invention has two plates 23 and 24 which together define a guide passage 25 for the ticket leading to the inlet of a cylinder 26 whose inside cylindrical space 27 constitutes a temporary storage magazine for the ticket that is rolled against the inside surface of the cylindrical magazine 26. An inner core 28 defines the storage space as being an annular space 29 inside the cylindrical space 27 so as to guide winding of the ticket in this storage space and where necessary so as to entrain it if the core 28 is coupled to a drive motor.

In preferred manner, the core 28 is motor-driven so as to be capable of turning in either direction so as to ensure that no jamming effect occurs while the ticket is being extracted and to ensure that no capstan effect of the paper winding onto the core 28 should impede such extraction.

Mention is also made of the presence of a fourth secondary roller 30 (or a line of wheels) mounted on an axis 30a which is urged to press against the roller 10 by a spring 31. The roller 30 projects into the inside of the deflector surface 16 so as to co-operate with the roller 10 in order to facilitate inserting paper into the inside of the device of the invention.

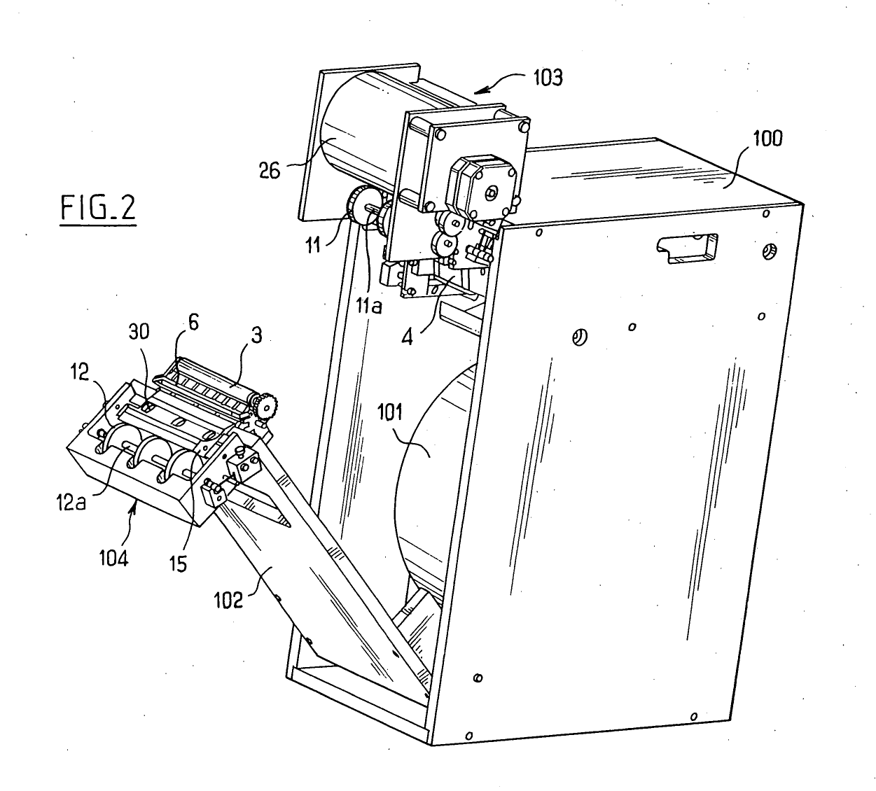

FIG. 2 shows an embodiment of the invention in combination with a box type printer, i.e. a printer housed in a structure 100 suitable for receiving a roll of paper 101 in a compartment that is closed by a tiltable door 102. The structure 100 carries the print head 2 and the rotary cutter blade 5 in conventional manner while the door 102 carries the capstan 3 and the stationary cutter blade 6.

In order to be compatible with printers that open in this way, the device of the invention is made up of two separable portions 103 and 104, one of which (103) is attached to the structure 100 of the printer and carries the magazine 26, the roller 10, the roller 11, and the flap 20, while the other one of which (104) is secured to the tiltable door 102 and carries the roller 12, the part 15 together with its deflector surfaces 16, 17, and 18, and the roller 30. when the door 102 is pressed against the structure 100, the capstan 3 slides under the print head 2 while the roller 30 comes into contact with the roller 10 and the roller 12 comes into contact with the roller 11, the part 15 being received under the flap 20 and closing the paper guide around the first and second rollers 10 and 11.

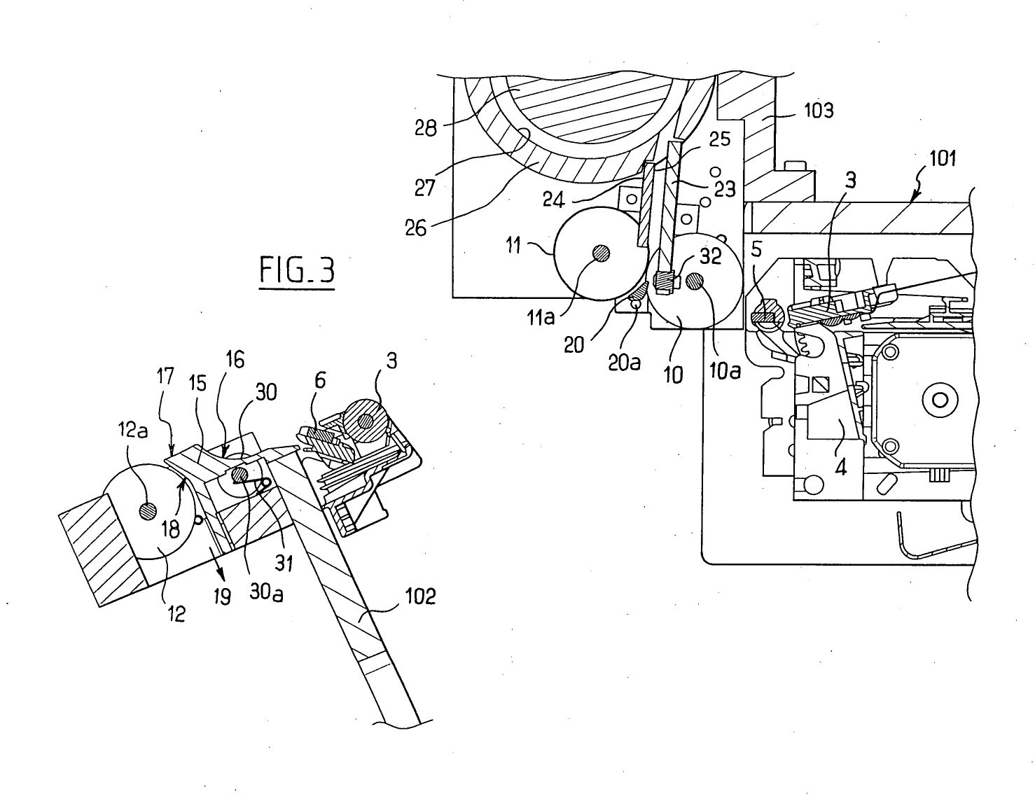

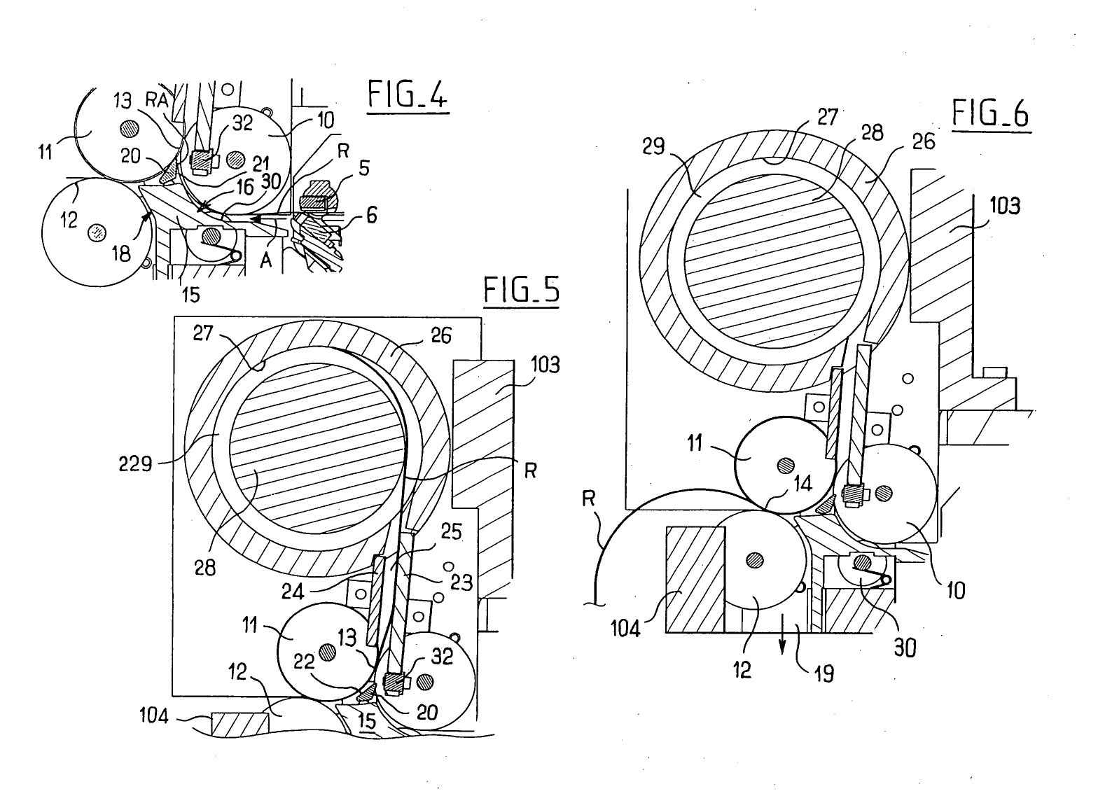

FIG. 3 is a section view of FIG. 2, the device and the printer both being open, in which there can be seen the elements as described above together with the same references. In this figure, it should be observed that the flap 20 is mounted on an axis 20a and is subjected to a return force about said axis 20a from a spring (not shown in the figure) urging it to move towards or be pressed against the roller 10, under a force that is relatively weak and that can be overcome by the leading edge of the paper on coming into contact with the flap 20, as shown in FIG. 4. In a variant that is not shown, this flap may be replaced by a lip secured to the part 15 and curved towards the roller 10, and that is held elastically by shape memory in this state.

In FIG. 4, it can be seen that the tape R of paper coming from the printer between the blades 5 and 6 penetrate into the first guide formed by the deflector surface 16, the roller 10, and the roller 30, with the leading edge RA of the paper tape being forced into contact with the flap 20, firstly by the driving force from the printer capstan 3, and secondly by the roller 10 rotating with the tape R being pressed thereagainst under relatively weak force by the roller 30. In this context, it should be observed that the rollers 10, 11, and 12 are driven in rotation, e.g. by coupling the roller 11 with a drive motor, while the rollers 10 and 12 are driven by friction, the drive being at a speed such that the peripheral speed of the roller 10 is greater than the peripheral speed of the capstan 3. This causes the strip of paper 5 to slip relative to the roller 10 so long as the printer is printing.

After raising the flap 20, the leading edge RA of the paper reaches the pinch line 13 which assists in entraining the paper into the passage 25 leading to the magazine 26 (see FIG. 5). At the end of printing, rotation of the capstan 3 and of the rollers 10, 11, and 12 is stopped and the paper is cut by causing the blade 5 to rotate. Once the paper has been cut, drive to the rollers 10, 11, and 12 is reactivated. The ticket is driven by the rollers 10 and 11 via the pinch line 13 until the moment when the flap 20 drops back against the roller 10. At this moment, rotation is stopped and the trailing portion of the ticket remains captive in the pinch line 13.

The following step in controlling the device consists in reversing the direction of rotation of the rollers 10, 11, and 12 so that the trailing edge of the ticket, guided by the deflector surface 22 of the flap 20 and by the deflector surface 17 of the part 15 is taken to the pinch line 14. The ticket is then wound out from the magazine 26, with this being assisted, where necessary, by the core 28 rotating until the leading edge of the ticket is detected by an optical detector 32 situated between the flap 20 and the pinch line 13, thereby causing rotation of the rollers to stop as the leading edge RA of the ticket goes past, which edge in this travel direction has become the trailing edge.

This state of the device is shown in FIG. 6. If the user does not take hold of the ticket R presented to the user by the device, then after a certain length of time has elapsed or at the discretion of the clerk, for example, the rollers 10, 11, and 12 are again set into rotation, in the direction for causing the ticket to be “swallowed” by the device whereupon it is brought to the deflector surface 18 which diverts it into the discharge channel 19 therefrom leading to a receptacle.

What is claimed is:

1. A device for making a printed ticket available, the device comprising at least three rollers or lines of wheels rotatable about respective parallel axes extending substantially transversely across the path of the ticket and situated, in end view, at the vertices of a triangle and defining two ticket pinch lines, one between a first roller and a second roller, and the other between said second roller and a third roller, wherein a first deflector surface co-operates with the first roller to define a first guide for guiding the ticket from a ticket supply source to a first pinch line, wherein a second deflector surface co-operates with the second roller to define a second guide for guiding the ticket from the first pinch line to a second pinch line, and wherein the third roller co-operates with a third deflector surface to define a third guide for guiding the ticket from the second pinch line to a ticket collection channel, the three guides being inscribed within the above-mentioned triangle.

2. A device according to claim 1, wherein the ends of the first deflector surface and of the second deflector surface adjacent to the first pinch line comprise two faces converging towards said line on a common moving part subjected to a return force towards the above-mentioned first roller.

3. A device according to claim 1, wherein one of the rollers is coupled to a drive motor.

4. A device according to claim 1, wherein the first deflector surface contains the generator line of a fourth roller in contact with the first roller.

5. A device according to claim 1, including a magazine for temporarily storing the ticket and situated beyond the first pinch line outside the above-mentioned triangle.

6. A device according to claim 2, including a detector for detecting the passage of a transverse edge of the paper through the second guide between the end of the above-mentioned moving part and the first pinch line.

7. A device according to claim 5, wherein the magazine comprises an external cage defining a cylindrical housing in which the paper can be wound freely inside the cage.

8. A device according to claim 7, wherein the cage includes a motor-driven cylindrical central core.

9. A device according to claim 1, comprising two portions that are movable relative to each other between an in-service position in which the first and second deflector surfaces are in the vicinity of the corresponding rollers, the second pinch line being established, and an open position in which the first and second deflector surfaces are moved at least in part away from the corresponding rollers, as are the second and third rollers such that a paper tape can pass freely between the two portions when they are in their second position.
